(19) United States
(12) Patent Application Publication
(10) Pub. No.: US 2024/0298650 A1
(43) Pub. Date: Sep. 12, 2024

(54) METHOD FOR PRODUCING PLANT BIOSTIMULANT FROM MARINE PLANTS

(71) Applicant: Tariq Abdul-Akbar, Baltimore, MD (US)

(72) Inventor: Tariq Abdul-Akbar, Baltimore, MD (US)

(21) Appl. No.: 18/486,118

(22) Filed: Oct. 12, 2023

Related U.S. Application Data
(60) Provisional application No. 63/379,279, filed on Oct. 12, 2022.

(51) Int. Cl. A01N 65/03; A01N 63/10; A01N 65/06; A01N 65/08; A01N 65/34; A01N 65/36; A01N 65/40; A01P 21/00; C05D 9/00; C05F 3/00; C05F 11/00; C05F 17/10

(52) U.S. Cl. CPC A01N 65/03; A01N 63/10; A01N 65/06; A01N 65/08; A01N 65/34; A01N 65/36; A01N 65/40; A01P 21/00; C05D 9/00; C05F 3/00; C05F 11/00; C05F 17/10

(57) ABSTRACT

Disclosed herein are methods for producing a plant biostimulant from marine plants. In one aspect, the present disclosure provides a biostimulant product produced by a novel and nonobvious process. In yet another aspect the biostimulant increases crop yields, fruit production, flower sets, and plant size. Biostimulant is an organic, non-toxic product that increases plant growth and invigorates plants. The plant biostimulant is produced from marine plants including but not limited to various types of seaweed.

### PRIORITY CLAIM

This application is a U.S. Non-Provision Utility Application entitled, “METHOD FOR PRODUCING PLANT BIOSTIMULANT FROM MARINE PLANTS” which claims priority to co-pending U.S. Provisional Application No. 63/379,279 filed Oct. 12, 2022 entitled, “METHOD FOR PRODUCING PLANT BIOSTIMULANT FROM MARINE PLANTS” the entirety of which is hereby incorporated by reference as if fully set forth herein.

### FIELD OF PRESENT DISCLOSURE

The present disclosure relates to a biostimulants, fertilizers, and other compositions which promote the growth of flora and fauna. The field of the disclosure may include but not be limited to the classifications: C05G3/00 Mixtures of one or more fertilizers with additives not having a specially fertilizing activity; A01N63/00 Biocides, pest repellants or attractants, or plant growth regulators containing microorganisms, viruses, microbial fungi, animals or substances produced by, or obtained from, microorganisms, viruses, microbial fungi or animals, e.g. enzymes or fermentates (containing compounds of determined constitution A01N27/00-A01N59/00; unicellular algae A01N65/03); C05F11/00 Other organic fertilizers; A01N43/00 Biocides, pest repellants or attractants, or plant growth regulators containing heterocyclic compounds; A01N65/00 Biocides, pest repellants or attractants, or plant growth regulators containing material from algae, lichens, Bryophyta, multi-cellular fungi or plants, or extracts thereof (containing compounds of determined constitution A01N27/00-A01N59/00); C12N1/00 Microorganisms, e.g. protozoa; Compositions thereof (medicinal preparations containing material from protozoa, bacteria or viruses A61K35/66, from algae A61K36/02, from fungi A61K36/06; preparing medicinal bacterial antigen or antibody compositions, e.g. bacterial vaccines, A61K39/00); Processes of propagating, maintaining or preserving microorganisms or compositions thereof; Processes of preparing or isolating a composition containing a microorganism; Culture media therefore; A01N25/00 Biocides, pest repellants or attractants, or plant growth regulators, characterized by their forms, or by their non-active ingredients or by their methods of application, e.g. seed treatment or sequential application; Substances for reducing the noxious effect of the active ingredients to organisms other than pests; A01N37/00 Biocides, pest repellants or attractants, or plant growth regulators containing organic compounds containing a carbon atom having three bonds to hetero atoms with at the most two bonds to halogen, e.g. carboxylic acids (containing cyclopropane carboxylic acids or derivatives thereof, e.g. cyclopropane carboxylic acid nitriles, A01N53/00); A01C21/00 Methods of fertilizing, sowing or planting; C05G5/00 Fertilizers characterized by their form; A01G33/00 Cultivation of seaweed or algae; A61K36/00 Medicinal preparations of undetermined constitution containing material from algae, lichens, fungi or plants, or derivatives thereof, e.g. traditional herbal medicines (antigens from pollen A61K39/36); B01J13/00 Colloid chemistry, e.g. the production of colloidal materials or their solutions, not otherwise provided for; Making microcapsules or microballoons.

### BACKGROUND OF THE PRESENT DISCLOSURE

In some situations, the primary methodologies of producing biostimulant from seaweeds come from the alkaline hydrolysis of brown seaweeds species from temperate waters. For example, the most common methods of hydrolysis utilizes high alkaline solutions that liquifies the components of seaweed. The most obvious problem of using alkaline hydrolysis is that red seaweeds will become a gooey substance, not a liquid. Using alkaline hydrolysis on red seaweeds is not effective for 3 reasons: Firstly, there is a high amount of ph. positive minerals in red seaweeds that won't be extracted efficiently in a high ph. solution. Second, the high ph. level and high temperature, caused by a high ph. assisted by potassium hydroxide causes red seaweeds to melt and become gooey which will result in a substance that is not water soluble. Third, to much alkaline can also damage the integrity of organic molecules contained in the seaweeds. Other old examples include most brown seaweeds, the most common type of raw seaweed used in commercial seaweed liquid extract biostimulant preparations. All of the mainstream brands undergo alkaline hydrolysis and suffer from the same aforementioned challenges when applied to red seaweeds, making it unsuitable in the preparation of commercial biostimulants.

Accordingly, there remains a need for improved fertilizers and biostimulants. This need and other needs are satisfied by the various aspects of the present disclosure.

### SUMMARY OF THE PRESENT DISCLOSURE

In accordance with the purposes of the present disclosure, as embodied and broadly described herein, the present disclosure, in one aspect, relates to method for producing a plant biostimulant from marine plants. In an exemplary aspect, the present disclosure relates to a product from seaweeds that is useful to be applied on all types of crops and soils for the purpose of stimulating plant growth, enhancing plant qualities and promoting soil biology. More specifically this invention refers to a biostimulant product made from seaweeds via a specific process which is beneficial to be applied on all type of crops and farming practices including conventional and organic. The products increases plant nutrient absorption and plant qualities and crop quality and crop yields.

In further aspects, the present disclosure also relates to a novel and nonobvious solution for producing biostimulants from marine plants in a manner that is highly efficient, affordable, and extremely effective product produced by a unique process.

In some aspects, the techniques described herein relate to a method for producing a biostimulant from an organic composition, including: a seaweed plant base selected from the group consisting of macroalgae, brown algae (Phaeophyceae), green algae (Chlorophyta), red algae (Rhodophyta), blue-green algae (Cyanobacteria), raw organic Eucheuma spinnosum, seagrass, sargassum, alcalase, aloe vera, ginger, and mixtures thereof; a fermentation element selected from the group consisting of a rabbit urine, phosphorus, potassium, organic waste product, bone ash, organic residues, digestates, effluent, and microbial decomposed products, and mixtures thereof.

Additional aspects of the present disclosure will be set forth in part in the description which follows, and in part will be obvious from the description, or can be learned by practice of the present disclosure. The advantages of the present disclosure will be realized and attained by means of the elements and combinations particularly pointed out in the appended claims. It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate several aspects of the present disclosure and together with the description, serve to explain the principles of the present disclosure.

FIG. 1A-1G shows a depiction of a flowchart depicting the method for producing plant biostimulant from marine plants in accordance with an exemplary embodiment of the present disclosure.

FIG. 2 shows crop growth with the biostimulant and without in accordance with an exemplary embodiment of the present disclosure.

FIG. 3 shows root growth with the biostimulant and without in accordance with an exemplary embodiment of the present disclosure.

FIG. 4 shows crop growth with the biostimulant and without in accordance with an exemplary embodiment of the present disclosure.

FIG. 5 shows crop growth with the biostimulant and without in accordance with an exemplary embodiment of the present disclosure.

FIG. 6 shows crop growth with the biostimulant and without in accordance with an exemplary embodiment of the present disclosure.

### DETAILED DESCRIPTION OF THE PRESENT DISCLOSURE

The present disclosure can be understood more readily by reference to the following detailed description of the present disclosure and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure relates, in various aspects, to method for producing a plant biostimulant from marine plants. In one aspect, the present disclosure provides a biostimulant product produced by a novel and nonobvious process.

Currently, the primary methodologies of producing biostimulant from seaweeds come from alkaline hydrolysis of brown seaweeds species from temperate waters. The most common methods of hydrolysis is by high alkaline solutions that liquify the components of seaweed.

Comparatively, the product of the current invention differs from other products because of the carbon elution-based extraction process that are used in this invention and the completely organic nature of all of its ingredients. Furthermore, this invention requires a lower quantity application dose than other products, making it more cost effective.

The use of multiple processing methods results in a higher quality concentrated sea-weed liquid extract that requires smaller application amounts than other biostimulants.

In further aspects, the present invention discloses a biostimulant product that is able to improve seed germination rates, time and vigor, increase plant growth rates and increase yields of a wide range of crops, improve resistance to biotic and abiotic stressors while increasing plant nutrient uptake. This is because this biostimulant contains organic molecules that interact with crops on a molecular level to trigger reactions at a genetic level-improving total crop productivity. This invention is important because speeds up growth and improves yields while mitigating the impact of climate change on abiotic and biotic stressors on crops.

In order to obtain the product effectively, the current biostimulant formation for improving plant growth consist of: liquid extracts derived from at least one carrageenan containing seaweed red seaweed and one or a combination of: seagrass, green seaweeds, non-seaweed marine plant, brown seaweeds, marsh grass.

In an aspect of the current invention, there is provided a method of preparing a biostimulant consisting of: a) liquid extracts derived from at least one seaweed species. The methods of preparation consist of: i) carbon and ph. assisted extraction; ii) heat extraction iii) enzymatic extraction.

The present invention utilizes carrageenan containing seaweeds that are produced commercially in coastal areas in addition to wild seagrasses, sargassum and marsh grasses.

Chemical analysis of seaweeds show that they are composed of compounds containing minerals, carbohydrates, vitamins, amino acids, plant hormones, enzymes, and useful biologically active compounds. They are made available to plants by this innovative method of extraction, consequently providing to the plants a liquid form of those compounds that are water soluble and highly available to biological life forms.

Seaweed extract contain sufficient amounts of water soluble important micronutrients, due to being a nutrient absorbing plant that grows in the ocean. The ocean contains large amounts of minerals for plant growth and health and nano amounts of other minerals that have an impact on plant growth. Minerals are also necessary for biological growth and health. Minerals contained in seaweeds, when applied to plants, also improves the nutrition profile.

Seaweed extract contain carbohydrates. Carbohydrates are useful in improving soil texture and oxygen flow, thus making it easier for plant roots to obtain oxygen and penetrate the soil. Carbohydrates also feed beneficial soil microorganisms and help to balance soil ph. Carbohydrates are an important component of plant cells.

A wide range of vitamins are contained in seaweed extract. Vitamins are regarded as important growth factors in plants and aid in plant growth, nutrition profile and health.

Seaweeds are rich in amino acids. Amino acids play a role in genetic expression and other metabolic roles. Amino acids also contain precursors to nitrogen and other important nitrogen containing compounds such as nucleic acids. Plants also use nitrogen to build amino acids that are in their cells, but the seaweeds contain amino acids that are supplied directly which reduces the need for the plant to use energy to make its own amino acids. Amino acids, therefore, help plants to express more growth vitality, disease resistance and an increased nutrition profile.

Seaweed contains phytohormones and phytosterols which help them to survive in a saline alkaline marine environment. Phytohormones and phytosterols are effective in micro amounts and they help plant growth by inducing new growth and coordinating activity within the plant. Phytohormones and phytosterols also act to induce immunity against pathogens and to produce better production of fruits and vegetation.

Seaweeds produce enzymes that have been shown to reduce plant stress and induce flowering and fruiting. These enzymes are regarded as growth and immunity promoting agents.

The product from this invention extracts minerals, vitamins, amino acids, plant hormones and enzymes from the seaweed and improves the usefulness of those compounds to the plants due to the following reasons:\

PH assisted extraction using a carbon-based lye allows for the maximum extraction of compounds from the seaweed as carbon binds to almost any molecule to form organic compounds while the high ph. hydrolysis's the molecules within the seaweed.

Heat extraction breaks down the molecules in the seaweeds, effectively liquifying its contents. Enzymatic hydrolysis helps to break down large chains of organic molecules into smaller molecules that are more easily absorbed by the plant. Furthermore, it produces L-amino acids that are taken up rapidly by the plant to form cells and do other functions.

In summary, the method claimed extracts the compounds of the seaweed through a combination of carbon alkaline extraction, heat and enzymatic extractions in order to get the maximum amount of compounds from the seaweed.

Lastly, this product contains organic matter that can improve soil texture and composition and help to increase the microbial population.

Methods for Producing Plant Biostimulant from Marine Plants

The following describes a methodology and a procedure to produce an organic biostimulant. These values and times are ranges which may vary depending on availability of elements, temperature and conditions, air pressure, and other factors and considerations.

### Exemplary Method

Step 1. Procure dried red seaweed including but not limited to: Agardhiella teneram, kappaphycus alvarezii, eucheuma spinosum, chondrus crispus, gracilaria sp., and like seaweed. The seaweed medium should be at least 80% purple, dark brown, green or red and covered in crystals. The seaweed must be weighed during this step.

Step 2. The seaweed must be washed and rinsed until the salt is gone.

Step 3. Add 3 parts of water to volume (i.e., add 75 L of water to 25 kg of seaweed).

Step 4. Add 250 ml of biphosphate per 50 L of water and mix well.

Step 5. Add citric acid until ph. level is between 5.5-5.9

Step 6. Soak for a time period ranging from 24 to 48 hours

Step 7. Remove seaweed from the water

Step 8. Add 250 ml of high organic nitrogen substance (fish, blood, urine) per 25 L of water

Step 9. Collect fresh seagrass, green or brown seaweed. Any one or mixture of those should be collected fresh during the time of low tide.

Step 10. Wash and rinse immediately in fresh water as to remove, sand, debris and salt.

\Step 11. Mince seaweed until it is no more than 3 mm in diameter.

Step 12. Press seaweed until the water is gone and save water in a separate container

Step 13. Add seaweed to the water where carrageenan containing seaweed was soaked.

Step 14. Heat mixture to 100 degrees Celsius and agitate for 30 minutes.

Step 15. Reduce heat to 55 degrees Celsius and add 10 grams alcalase enzyme per 25 L of water.

Step 16. Agitate at 55 degrees Celsius for 3 hours

Step 17. After a period of at least 2 hours add approximately 0.5 kg minced fresh ginger per 150 L, approximately 0.5 kg minced fresh aloe vera per 150 L of water and approximately 100 ml of acetic acid per 25 ml of water.

Step 18. When 3 hours is over, filter the liquid from the solid seaweed residue Step 19. Press the solid seaweed residue

Step 20. Add water from step 12 to the mixture.

Step 21. Filter liquid

Step 22. Heat liquid at 87 degrees Celsius for 12 minutes

Step 23. Put liquid content into sterile packaging for liquids

Step 24. Spray dry and package powder

### Other Examples of Use and Application of Biostimulant

Mix 1 ml of biostimulant per 1 liter of water and water seeds after sowing. Germination speed and percentage increases.

Mix 1 ml of biostimulant per 1 liter of water and water cuttings at time of sowing. Rooting time decreases and root mass increases.

Mix 1 ml of biostimulant per 1 liter of water and spray crops with a fine mist at budding stage. Flowers and fruit set/fruit sizes increase. Crop also has a longer shelf life due to antioxidation effect.

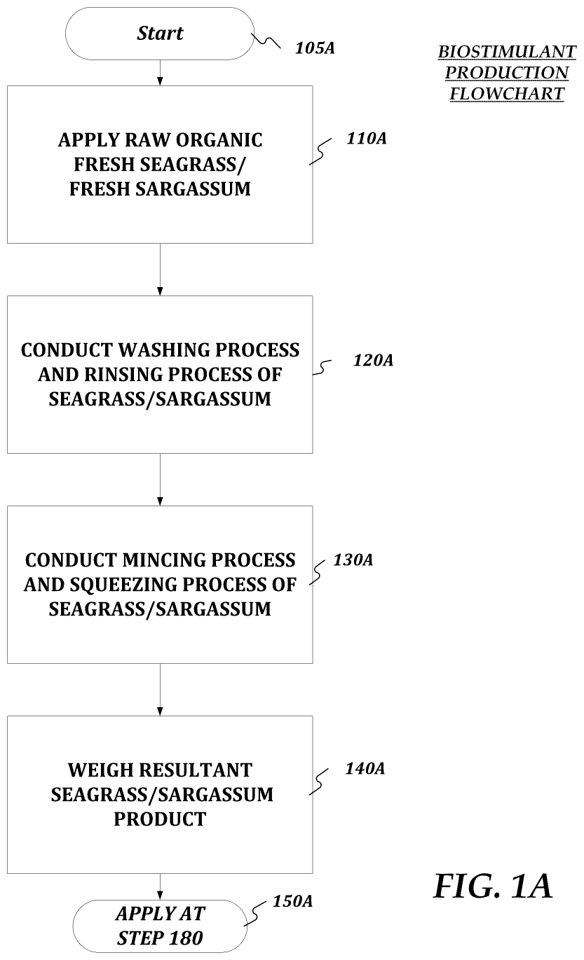

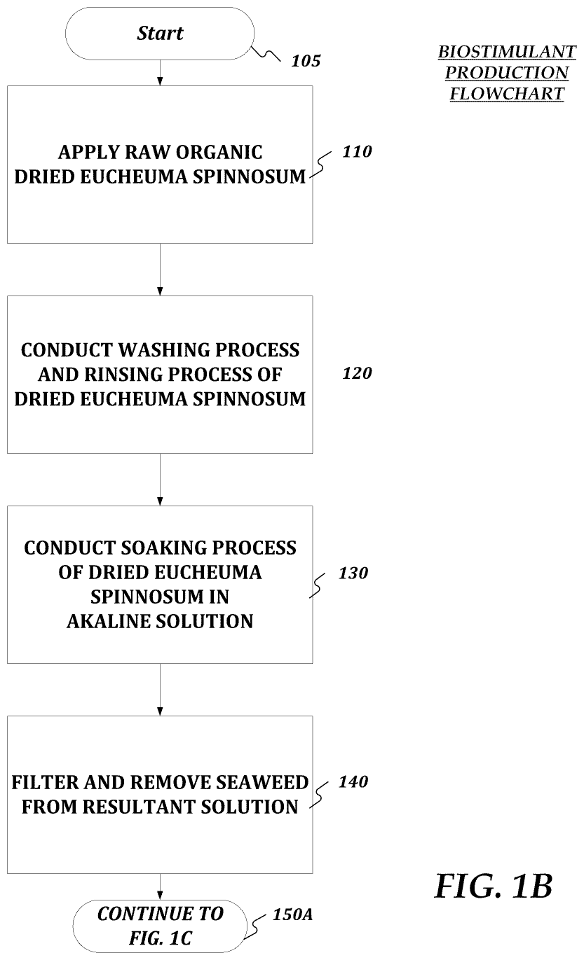

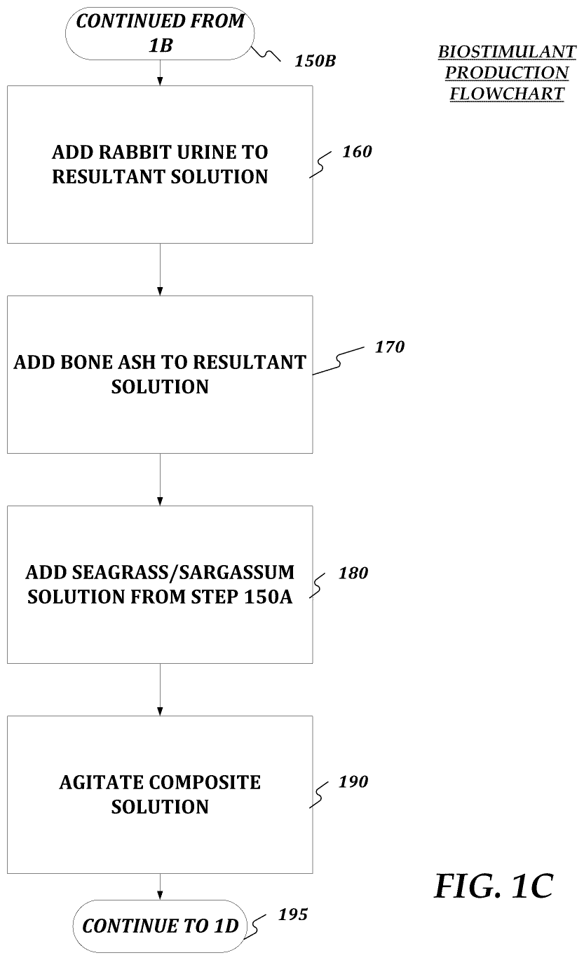

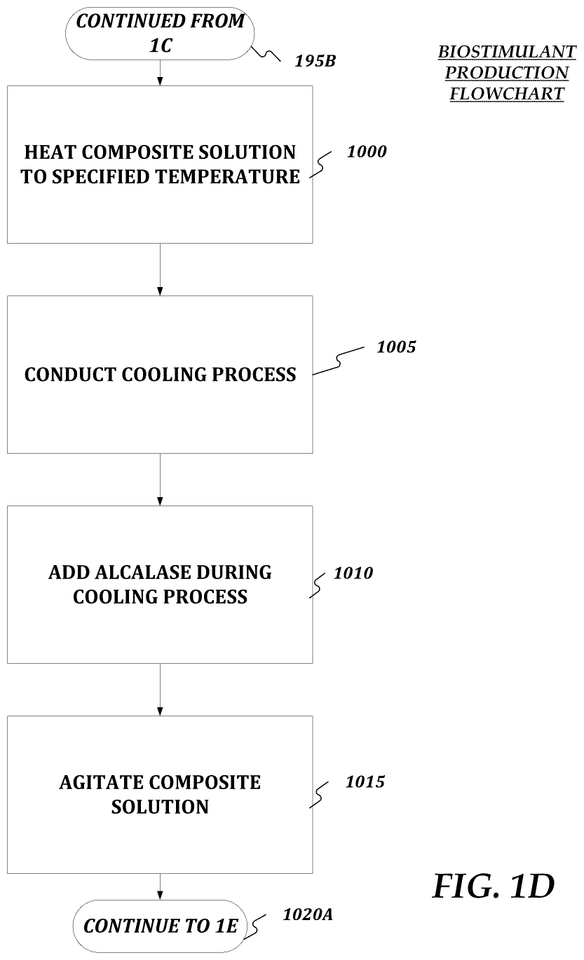

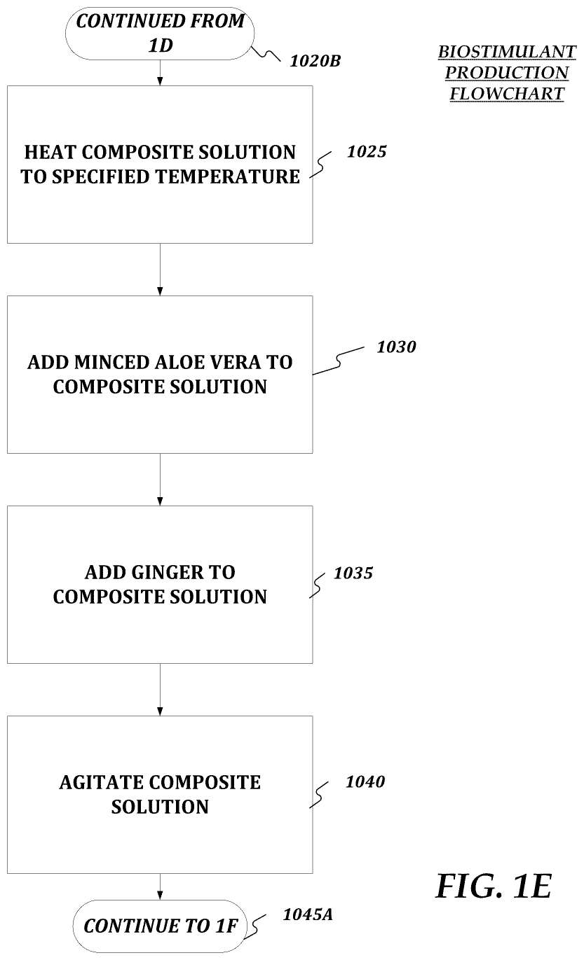

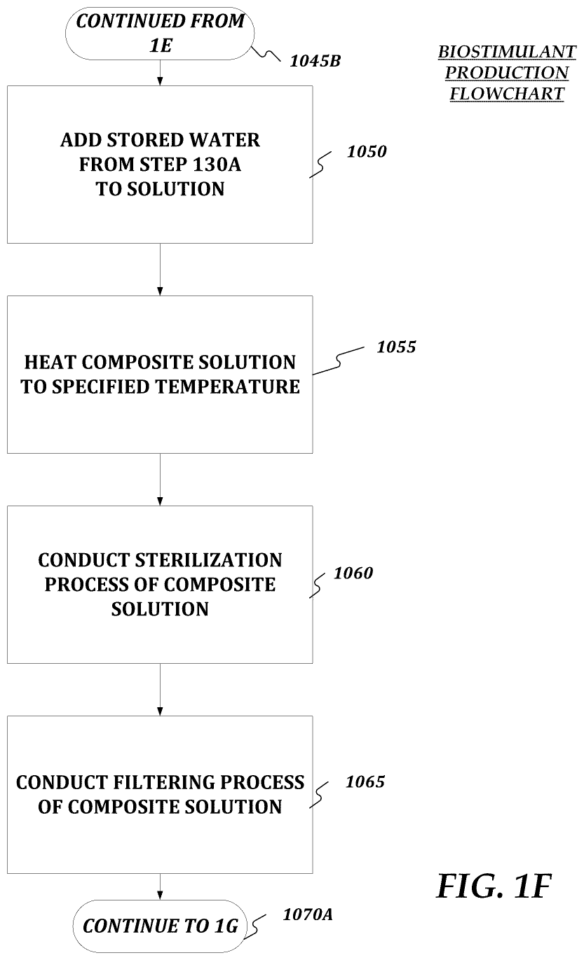

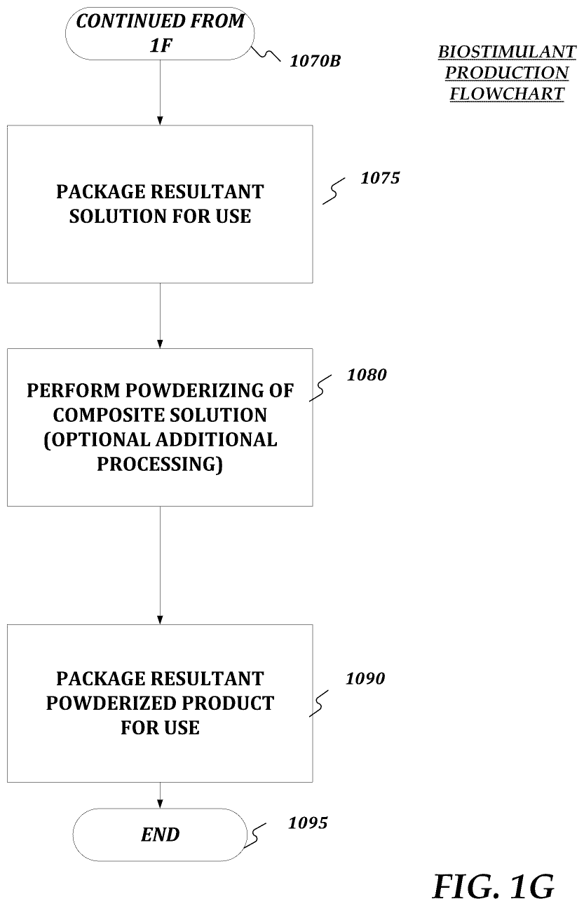

In still further aspects, FIG. 1A-1G shows a depiction of a flowchart depicting the method for producing plant biostimulant from marine plants in accordance with an exemplary embodiment of the present disclosure. Regarding FIG. 1A, method may begin at starting block 105A and proceed to stage 110A where one may apply raw organic fresh seagrass or free sargassum.

From stage 110A, where a user applied raw organic fresh seagrass or free sargassum, method may advance to stage 120A where a user may conduct a washing process and rinsing process of seagrass or sargassum.

Once a user conducts the washing process and rinsing process of seagrass or sargassum in stage 120A, method may continue to stage 130A where a user may conduct a mincing process and squeezing process of seagrass or sargassum.

After a user conducts a mincing process and squeezing process of seagrass or sargassum in stage 130A, method may proceed to stage 140A where a user may weigh resultant seagrass or sargassum product. Once the user weighs resultant seagrass or sargassum product in stage 140A, method may then continue to step 150A which requires a user to set aside or store the resultant seagrass or sargassum product to later be applied at stage 180.

Method may begin at starting block 105A and proceed to stage 110A where one may apply raw organic fresh seagrass or free sargassum.

From stage 110A, where a user applied raw organic fresh seagrass or free sargassum, method may advance to stage 120A where a user may conduct a washing process and rinsing process of seagrass or sargassum.

Once a user conducts the washing process and rinsing process of seagrass or sargassum in stage 120A, method may continue to stage 130A where a user may conduct a mincing process and squeezing process of seagrass or sargassum.

After a user conducts a mincing process and squeezing process of seagrass or sargassum in stage 130A, method may proceed to stage 140A where a user may weigh resultant seagrass or sargassum product. Once the user weighs resultant seagrass or sargassum product in stage 140A, method may then continue to step 150A which requires a user to set aside or store the resultant seagrass or sargassum product to later be applied at stage 180.

Regarding FIG. 1B, method may begin at starting block 105 and proceed to stage 110 where one may apply raw organic dried Eucheuma spinnosum.

From stage 110, where a user applied raw organic dried Eucheuma spinnosum, method may advance to stage 120 where a user may conduct a washing process and rinsing process of dried Eucheuma spinnosum.

Once a user conducts the washing process and rinsing process of dried Eucheuma spinnosum in stage 120, method may continue to stage 130 where a user may conduct a soaking process of dried Eucheuma spinnosum in alkaline solution.

After a user conducts a soaking process of dried Eucheuma spinnosum in alkaline solution in stage 130, method may proceed to stage 140 where a user may filter and remove seaweed from resultant solution. Once the user filters and removes seaweed from resultant solution in stage 140, method may then continue to step 150A.

Method may continue at starting block 150B and proceed to stage 160 where one may add rabbit urea to resultant solution.

From stage 160, where a user added rabbit urea to resultant solution, method may advance to stage 170 where a user may add bone ash to resultant solution from 160.

Once a user adds bone ash to resultant solution from 160 in stage 170, method may continue to stage 180 where a user may add seagrass or sargassum from stage 150A.

After a user added add seagrass or sargassum from stage 150A in stage 180, method may proceed to stage 190 where a user may agitate composite solution. Once the user agitate composite solution in stage 190, method may then continue to step 195.

Method may continue at block 195B and proceed to stage 1000 where one may heat composite solution to specified temperature.

From stage 1000, where a user heated composite solution to specified temperature, method may advance to stage 1005 where a user may conduct a cooling process.

Once a user conducts the cooling process in stage 1010, method may continue to stage 1010 where a user may add alcalase during the cooling process.

After a user adds alcalase during the cooling process in stage 1010, method may proceed to stage 1015 where a user may agitate composite solution. Once the user agitates composite solution in stage 1015, method may then continue to step 1020A.

Method may continue at block 1020B and proceed to stage 1025 where one may heat composite solution to specified temperature.

From stage 1025, where a user heated composite solution to specified temperature, method may advance to stage 1030 where a user may add minced aloe vera to composite solution.

Once a user adds minced aloe vera to composite solution in stage 1030, method may continue to stage 1035 where a user may add ginger to composite solution.

After a user adds ginger to composite solution in stage 1035, method may proceed to stage 1040 where a user may agitate composite solution. Once the user agitates composite solution in stage 10140 method may then continue to step 1045A.

Method may continue at block 1045B and proceed to stage 1050 where one adds stored water from step 130A to solution.

From stage 1050, where a user added stored water from step 130A to solution, method may advance to stage 1055 where a user may heat composite solution to specified temperature.\

Once a user heat composite solution to specified temperature in stage 1055, method may continue to stage 1060 where a user may conduct sterilization process of composite solution.

After a user conducts sterilization process of composite solution in stage 1060, method may proceed to stage 1065 where a user may conduct a filtering process of the composite solution. Once the user conducts the filtering process of the composite solution in stage 1065, method may then continue to step 1070A.

Method may continue at block 1070B and proceed to stage 1075 where one may package resultant solution for use.

From stage 1075, where a user packages resultant solution for use, method may advance to stage 1080 where a user may perform powderizing of composite solution.

Once a user powderizing of composite solution in stage 1080, method may continue to stage 1090 where a user may package resultant powderized product for use.

The method may end at stage 1095.

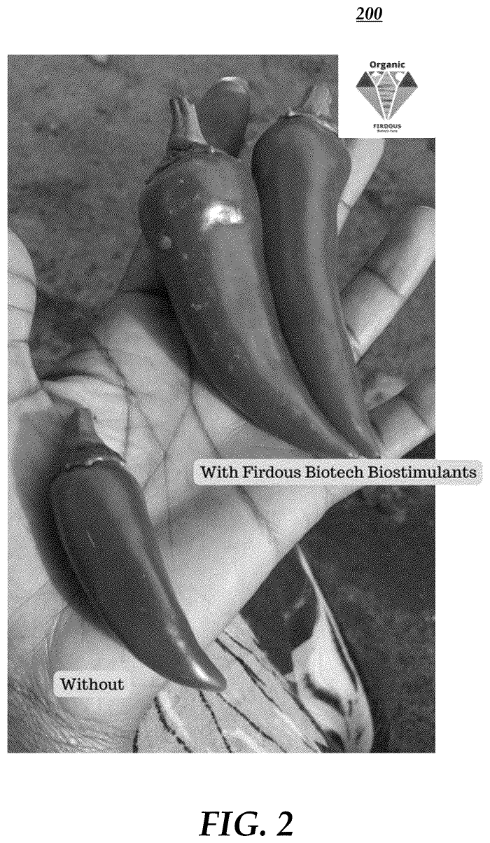

In even further aspects, FIG. 2 shows crop growth with the biostimulant and without in accordance with an exemplary embodiment of the present disclosure.

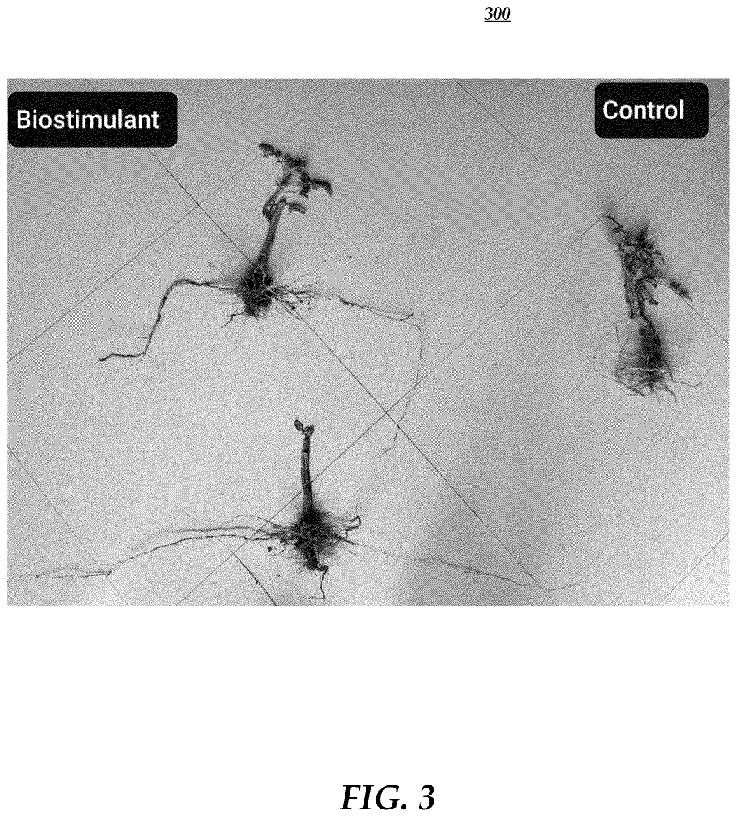

In further aspects, FIG. 3 shows root growth with the biostimulant and without in accordance with an exemplary embodiment of the present disclosure.

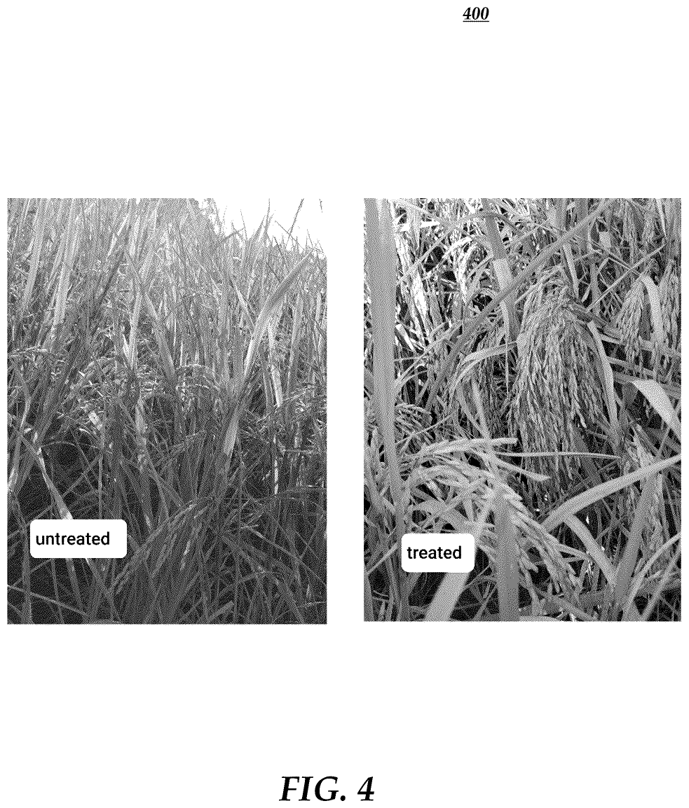

In still further aspects, FIG. 4 shows crop growth with the biostimulant and without in accordance with an exemplary embodiment of the present disclosure.

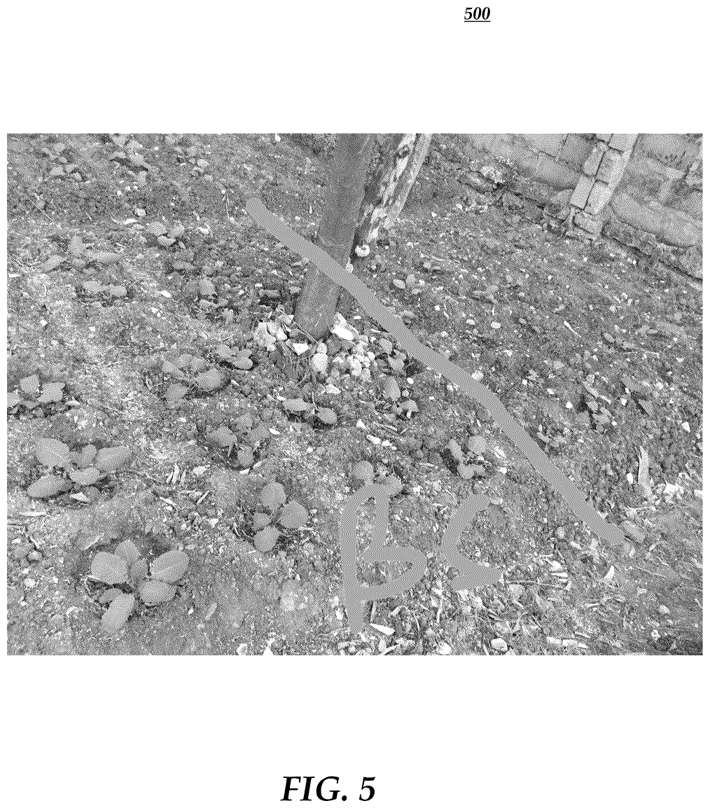

In even further aspects, FIG. 5 shows crop growth with the biostimulant and without in accordance with an exemplary embodiment of the present disclosure.

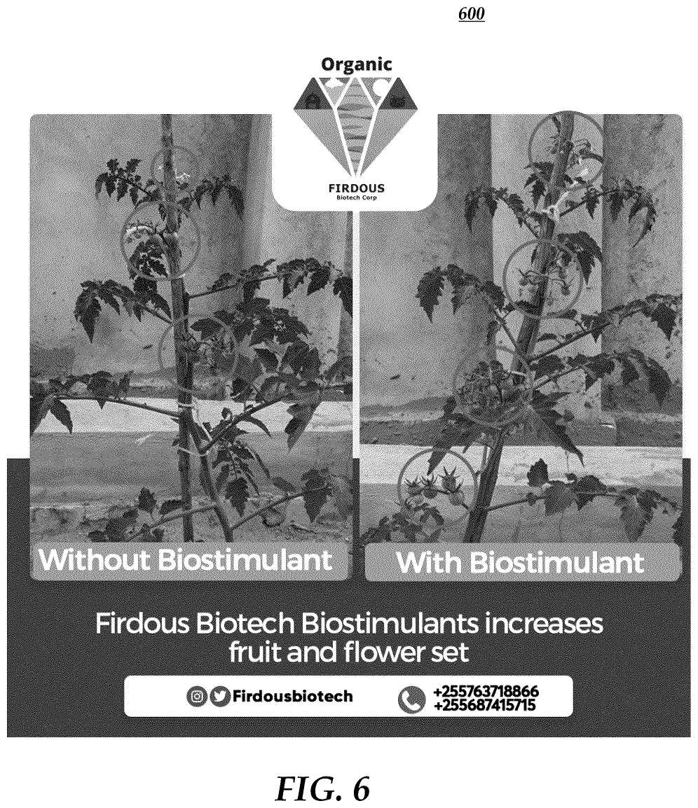

In another aspect, FIG. 6 shows crop growth with the biostimulant and without in accordance with an exemplary embodiment of the present disclosure.

According to various further aspects of the present disclosure, the method for producing plant biostimulant from marine plants can comprise multiple configurations. For example, various exemplary embodiments of the method for producing plant biostimulant from marine plants are shown in FIGS. 1A-1G. In aspects, FIGS. 2-6 show various views and features of method for producing plant biostimulant from marine plants in accordance with the present disclosure.

In some aspects, the techniques described herein relate to a method for producing a biostimulant from an organic composition, including: a seaweed plant base selected from the group consisting of macroalgae, brown algae (Phaeophyceae), green algae (Chlorophyta), red algae (Rhodophyta), blue-green algae (Cyanobacteria), Agardhiella teneram, kappaphycus alvarezii, eucheuma spinosum, chondrus crispus, gracilaria sp., raw organic Eucheuma spinnosum, seagrass, sargassum, alcalase, aloe vera, ginger, and mixtures thereof; a fermentation element selected from the group consisting of a rabbit urine, phosphorus, potassium, organic waste product, bone ash, organic residues, digestates, effluent, and microbial decomposed products, and mixtures thereof; and an extraction process consisting of: liquid extracts derived from at least one seaweed species wherein the methods of preparation consist of at least one of: carbon and ph. assisted extraction, heat extraction, and enzymatic extraction

Regarding the fermentation elements, in some aspects, the techniques described herein relate to submerged liquid and solid-state fermentation processes for biostimulant production including the use of one or more biotechnological techniques to obtain microbial biomass or spores, which are further formulated into commercial products. In one or more aspects, fermentation may be expressed and utilized as the art of mass-cultivation of microorganisms, in the majority of cases using specific media and controlled process parameters, such as temperature, pH, aeration, and, if necessary, additional feeding.

In some aspects, the techniques described herein relate to Another biotechnological method of bioinocula production could be the traditional single liquid batch fermentation operation model. Particularly the fed-batch mode of fermentation has been successfully experimented in biofertilizer mass production, although this approach has been more frequently used in other biotechnological processes. The fed-batch fermentation operation involves an intermittent feeding of substrate or DO-based and pH-based feeding to ensure a determined rate of consumption when the substrate concentration decreases to a minimum. In the field of plant beneficial microbial production, fed-batch fermentation is an efficient tool for reaching a sufficiently high biomass or high concentration of phyto-stimulating metabolites.

In some aspects, the techniques described herein relate to an immobilized-cell based fermentation process. An immobilized cell system is composed by three components: the cells, the matrix (carriers), where cells are immobilized, and the solution that occupies the rest of the matrix and may contain additives. The methods of immobilization are different, but mainly based on adsorption on solid carriers and (macro/micro)-encapsulation in gels. Immobilized systems are widely used in various biotechnological processes, but are still limited for agricultural purposes. In particular, immobilized cell technologies are used to study the behavioral changes in cells of plant beneficial microorganisms as the immobilized state is the normal state of microorganisms in soil. These methods are also involved in formulation of biofertilizers.

In some aspects, the techniques described herein relate to a solid-state fermentation process. Solid-state fermentation (SSF) is a fermentation process based on substrates in solid forms and carried out in the absence of free water. This mode of fermentation has attracted the attention of many scientists because it is in fact a natural process, with high economic potential, which can be easily performed in laboratory and industrial conditions to produce various microbial products, including biofertilizers, while recycling residual agro-industrial materials

In some aspects, the techniques described herein relate to a key fermentation parameters. Independently of the mode of fermentation (submerged or solid-state) or cell state (free or immobilized), we can always improve the process productivity by optimizing the initial pH, agitation rate, aeration volume, initial inoculum concentration, and (in SSF) initial moisture and type of the moistening agent. The assessment of the effect of different fermentation parameters on the biomass accumulation and cell survival in the bioformulates during storage is essential to the development of stable commercial products. The optimization schemes and experiments are normally carried out in controlled conditions simultaneously or by analyzing the effect of one parameter (variable) at a time, independently of the mode of fermentation (solid, liquid, free/immobilized cells, etc.).

In some aspects, the techniques described herein relate to improved methods of fermentation and modes for increasing industrial production of biostimulant to increase plant growth. The aim of the cultivation of plant beneficial microorganisms is to further prepare formulated commercial products based on biomass, spores and eventually the fermentation liquid, which contains plant-stimulating or biocontrol metabolites [10]. The selection of the fermentation mode can be determined experimentally as microbial biomass and spores from plant beneficial microorganisms can be produced by both submerged and solid-state fermentations. The first process, either as a single batch or fed-batch, is the most effective and accepted method for the production of biomass, spores, and metabolites on an industrial scale. On the other hand, the second one is instead a relatively well-established fermentation technology for the production of various metabolic products and significant amount of biomass and spores.

### Aspects and Formulations

In some aspects, the techniques described herein relate to a method for producing a biostimulant from an organic composition, including: a seaweed plant base selected from the group consisting of macroalgae, brown algae (Phaeophyceae), green algae (Chlorophyta), red algae (Rhodophyta), blue-green algae (Cyanobacteria), raw organic Eucheuma spinnosum, seagrass, sargassum, alcalase, aloe vera, ginger, and mixtures thereof; a fermentation element selected from the group consisting of a rabbit urine, phosphorus, potassium, organic waste product, bone ash, organic residues, digestates, effluent, and microbial decomposed products, and mixtures thereof; and an extraction process consisting of: liquid extracts derived from at least one seaweed species wherein the methods of preparation consist of at least one of: carbon and ph. assisted extraction, heat extraction, and enzymatic extraction.

Various formulations for an organic plant biostimulant produced by a process for producing plant biostimulant from marine plants as specified in the specification following:

Aspect 1. A biostimulant composition, comprising:
a seaweed plant base comprising macroalgae, brown algae (Phaeophyceae), green algae (Chlorophyta), red algae (Rhodophyta), blue-green algae (Cyanobacteria), Agardhiella teneram, kappaphycus alvarezii, eucheuma spinosum, chondrus crispus, gracilaria sp., raw organic Eucheuma spinnosum, seagrass, sargassum, alcalase, aloe vera, ginger, and mixtures thereof;
a fermentation element comprising: rabbit urine, phosphorus, potassium, organic waste product, bone ash, organic residues, digestates, effluent, and microbial decomposed products, and mixtures thereof; and
an extraction process wherein a resultant liquid extract is derived from the seaweed plant base and fermentation element.

Aspect 2. The biostimulant composition of aspect 1, wherein the extraction process is produced by at least one of the methods of preparation comprising of at least one of: carbon and ph. assisted extraction, heat extraction, and enzymatic extraction.

Aspect 3. The biostimulant composition of aspect 1, wherein the fermentation element comprising, by weight:
about 25% rabbit urine;
about 15% of a solvent;
about 5% of a bone ash;
about 5% of an additive;
about 5% of a crosslinking agent; and
about 1% of a preservative.

Aspect 4. The biostimulant composition of aspect 1, wherein the water is present in an amount of from about 40% to about 60% by weight of the composition.

Aspect 5. The biostimulant composition of aspect 1, wherein the fermentation element is present in an amount of from about 25% to about 60% by weight of the composition.

Aspect 6. The biostimulant composition of aspect 1, wherein the of the seaweed plant base comprising, by weight:
about 20% natural gracilaria sp;
about 10% of a chondrus crispus;
about 5% of a stabilizer;
about 5% of an additive;
about 5% of a crosslinking agent; and
about 1% of a preservative.

Aspect 7. The biostimulant composition of aspect 6, wherein the additive is a fragrance additive comprising, by weight:
about 20% to about 35% bergamot oil;
about 15% to about 45% lemon oil;
about 10% to about 12% grapefruit oil; and
about 15% to about 45% orange oil.

Aspect 8. The biostimulant composition of aspect 6, wherein the additive is a fragrance additive comprising, by weight:
about 30% to about 45% rose absolute;
about 20% to about 40% jasmine absolute;
about 5% to about 30% neroli oil; and

about 5% to about 25% ylang-ylang oil.

Aspect 9. The biostimulant composition of aspect 8, wherein the additive is a fragrance additive comprising, by weight:
about 1% to about 5% cedarwood oil;
about 1% to about 5% sandalwood oil; and
about 1% to about 5% vanilla extract.

Aspect 10. The biostimulant composition of aspect 1, wherein the fermentation element is present in an amount of from about 1% to about 20% by weight of the composition.

Aspect 11. The biostimulant composition of aspect 1, wherein the seaweed plant base comprises a plurality of elements, the glitter selected from the group consisting of agardhiella teneram, kappaphycus alvarezii, eucheuma spinosum, chondrus crispus, gracilaria sp., and mixtures thereof.

Aspect 12. The biostimulant composition of aspect 11, wherein the plurality of elements of the seaweed plant base having a diameter less than 5 microns (μm).

Aspect 13. A formulation, comprising, by weight:
a seaweed plant base, comprising:
about 40% to about 75% gracilaria sp;
about 5% to about 7% Eucheuma spinosum; and
about 5% to about 5% solvent;
a fermentation element, comprising;
about 15% to about 65% rabbit urine; an;
about 0% to about 5% bone ash;
an additive, comprising:
about 1% to about 20% fragrance; and
water comprising:
about 30% to 40% pure water.

Aspect 14. The formulation of aspect 13, wherein the of the seaweed plant base further comprising, by weight:
about 20% natural gracilaria sp;
about 10% of a chondrus crispus;
about 5% of a stabilizer;
about 5% of an additive;
about 5% of a crosslinking agent; and
about 1% of a preservative.

Aspect 15. The formulation of aspect 13, wherein the additive is a fragrance additive comprising, by weight:
about 20% to about 35% bergamot oil;
about 15% to about 45% lemon oil;
about 10% to about 12% grapefruit oil; and
about 15% to about 45% orange oil.

Aspect 16. The formulation of aspect 13, wherein the additive is a fragrance additive comprising, by weight:
about 30% to about 45% rose absolute;
about 20% to about 40% jasmine absolute;
about 5% to about 30% neroli oil; and
about 5% to about 25% ylang-ylang oil.

Aspect 17. The formulation of aspect 13, wherein the additive is a fragrance additive comprising, by weight:
about 1% to about 5% cedarwood oil;
about 1% to about 5% sandalwood oil; and
about 1% to about 5% vanilla extract.

Aspect 18. The formulation of aspect 13, wherein the fermentation element is present in an amount of from about 1% to about 20% by weight of the composition.

Aspect 19. The formulation of aspect 13, wherein the solution comprising, by weight:
about 25% to about 90% seaweed plant base;
about 1% to about 10% additive;
about 1% to about 35% fermentation element; and
about 10% to about 80% deionized water.

Aspect 20. A composition, comprising:
a liquid seaweed base;
deionized water;
a fermentation element; and
an extraction process wherein a resultant biostimulant composition is derived from the liquid seaweed base, deionized water, and fermentation element.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A biostimulant composition, comprising:
a seaweed plant base comprising macroalgae, brown algae (Phaeophyceae), green algae (Chlorophyta), red algae (Rhodophyta), blue-green algae (Cyanobacteria), Agardhiella teneram, kappaphycus alvarezii, eucheuma spinosum, chondrus crispus, gracilaria sp., raw organic Eucheuma spinnosum, seagrass, sargassum, alcalase, aloe vera, ginger, and mixtures thereof;
a fermentation element comprising: rabbit urine, phosphorus, potassium, organic waste product, urea, fish waste product, slaughterhouse waste product, bat guano, bone ash, organic residues, digestates, effluent, and microbial decomposed products, and mixtures thereof; and
an extraction process wherein a resultant liquid extract is derived from the seaweed plant base and fermentation element.

2. The biostimulant composition of claim 1, wherein the extraction process is produced by at least one of the methods of preparation comprising of at least one of: carbon and ph. assisted extraction, heat extraction, and enzymatic extraction.

3. The biostimulant composition of claim 1, wherein the fermentation element comprising, by weight:
about 25% rabbit urine;
about 15% of a solvent;
about 5% of a bone ash;
about 5% of an additive;
about 5% of a crosslinking agent; and
about 1% of a preservative.

4. The biostimulant composition of claim 1, wherein the water is present in an amount of from about 40% to about 60% by weight of the composition.

5. The biostimulant composition of claim 1, wherein the fermentation element is present in an amount of from about 25% to about 60% by weight of the composition.

6. The biostimulant composition of claim 1, wherein the of the seaweed plant base comprising, by weight:
about 20% natural gracilaria sp;
about 10% of a chondrus crispus;
about 5% of a stabilizer;
about 5% of an additive;
about 5% of a crosslinking agent; and
about 1% of a preservative.

7. The biostimulant composition of claim 6, wherein the additive is a fragrance additive comprising, by weight:
about 20% to about 35% bergamot oil;
about 15% to about 45% lemon oil;
about 10% to about 12% grapefruit oil; and
about 15% to about 45% orange oil.

8. The biostimulant composition of claim 6, wherein the additive is a fragrance additive comprising, by weight:
about 30% to about 45% rose absolute;
about 20% to about 40% jasmine absolute;
about 5% to about 30% neroli oil; and
about 5% to about 25% ylang-ylang oil.

9. The biostimulant composition of claim 8, wherein the additive is a fragrance additive comprising, by weight:
about 1% to about 5% cedarwood oil;
about 1% to about 5% sandalwood oil; and
about 1% to about 5% vanilla extract.

10. The biostimulant composition of claim 1, wherein the fermentation element is present in an amount of from about 1% to about 20% by weight of the composition.

11. The biostimulant composition of claim 1, wherein the seaweed plant base comprises a plurality of elements, the glitter selected from the group consisting of agardhiella teneram, kappaphycus alvarezii, eucheuma spinosum, chondrus crispus, gracilaria sp., and mixtures thereof.

12. The biostimulant composition of claim 11, wherein the plurality of elements of the seaweed plant base having a diameter less than 5 microns (μm).

13. A formulation, comprising, by weight:
a seaweed plant base, comprising:
about 40% to about 75% gracilaria sp;
about 5% to about 7% Eucheuma spinosum; and
about 5% to about 5% solvent;
a fermentation element, comprising:
about 15% to about 65% rabbit urine; and
about 0% to about 5% bone ash;
an additive, comprising:
about 1% to about 20% fragrance; and
water comprising:
about 30% to 40% pure water.

14. The formulation of claim 13, wherein the of the seaweed plant base further comprising, by weight:
about 20% natural gracilaria sp;
about 10% of a chondrus crispus;
about 5% of a stabilizer;
about 5% of an additive;
about 5% of a crosslinking agent; and
about 1% of a preservative.

15. The formulation of claim 13, wherein the additive is a fragrance additive comprising, by weight:
about 20% to about 35% bergamot oil;
about 15% to about 45% lemon oil;
about 10% to about 12% grapefruit oil; and
about 15% to about 45% orange oil.

16. The formulation of claim 13, wherein the additive is a fragrance additive comprising, by weight:
about 30% to about 45% rose absolute;
about 20% to about 40% jasmine absolute;
about 5% to about 30% neroli oil; and
about 5% to about 25% ylang-ylang oil.

17. The formulation of claim 13, wherein the additive is a fragrance additive comprising, by weight:
about 1% to about 5% cedarwood oil;
about 1% to about 5% sandalwood oil; and
about 1% to about 5% vanilla extract.

18. The formulation of claim 13, wherein the fermentation element is present in an amount of from about 1% to about 20% by weight of the composition.

19. The formulation of claim 13, wherein the solution comprising, by weight:
about 25% to about 90% seaweed plant base;
about 1% to about 10% additive;
about 1% to about 35% fermentation element; and
about 10% to about 80% deionized water.

20. A composition, comprising:
a liquid seaweed base;
deionized water;
a fermentation element; and
an extraction process wherein a resultant biostimulant composition is derived from the liquid seaweed base, deionized water, and fermentation element.
